(19) United States
(12) Patent Application Publication
(10) Pub. No.: US 2010/0110673 A1
(43) Pub. Date: May 6, 2010

(54) LUMINAIRE WITH LEDS

(75) Inventors: Anthonie Hendrik Bergman, Eindhoven (NL); Tim Dekker, Eindhoven (NL); Michel Cornelis Josephus Marie Vissenberg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/445,342

(22) PCT Filed: Oct. 12, 2007
(86) PCT No.: PCT/IB07/54152

§ 371 Date: Apr. 13, 2009

(30) Foreign Application Priority Data
Oct. 16, 2006 (EP) 06122321.0
Jan. 11, 2007 (EP) 07100360.2

(51) Int. Cl. F21V 9/00; F21V 1/00

(52) U.S. Cl. 362/231; 362/235

(57) ABSTRACT

A luminaire comprises a light guiding layer (2) and a plurality of LEDs (7), which LEDs (7) are accommodated in at least one hole (10) arranged in the light guiding layer (2), for emitting light into the light guiding layer (2). The light guiding layer (2) further comprises at least one out-coupling structure (5; 6), for coupling the light out of the light guiding layer (2).

### FIELD OF THE INVENTION

The present invention relates to a luminaire comprising a light guiding layer and a plurality of light emitting diodes (LEDs) that emit light into the light guiding layer.

### BACKGROUND OF THE INVENTION

Progress in the brightness, lumen efficacy and affordability of solid state light sources such as light emitting diodes (LEDs) enables new lighting applications that are no longer restricted to niche markets. LEDs offer several advantages over traditional light sources, such as long lifetime, low operating voltage, instant on, etc. For these and other reasons, LEDs are becoming more and more suited for making lamps for several applications such as color variable lamps, spotlights, architectural lighting, stage lighting, etc.

For many lighting applications, the light of a single LED is not sufficient, and light of multiple LEDs needs to be combined to form a light source. One solution is to mix light of multiple LEDs in a light guide, before the light leaves the lighting device.

Today some lamps have LEDs arranged at an outer edge of a light guiding plate. The light emitted by the LEDs is coupled in at the edge of the plate and is mixed in the plate before it is coupled out from the plate. Typically, the plate has an out-coupling structure that is arranged in the plate at a distance from the plate edges. During operation, the LEDs generate heat as well as light, and it is often rather difficult to efficiently dissipate the heat.

To avoid excessive heat, the plate has heat sinks that lead heat way from the LEDs. However, the heat sinks often results in a rather bulky lamp structure.

Optionally, the LEDs are placed at a long enough distance from each other so that excessive building up of heat is prevented. Unfortunately, since the LEDs may not be concentrated on small area, this often renders it hard to obtain a desirable level of luminance.

### SUMMARY OF THE INVENTION

It is an object of the present invention to provide an improvement of the above techniques and prior art.

Other objects and advantages that will be apparent from the following description of the present invention are achieved by a luminaire according to the independent claim. Preferred embodiments are defined in the dependent claims.

Accordingly, a luminaire is provided, the luminaire comprising a light guiding layer, and a plurality of LEDs, which LEDs are accommodated in at least one hole arranged in the light guiding layer for emitting light into the light guiding layer. The light guiding layer comprises at least one out-coupling structure for coupling the light out of the light guiding layer.

The inventive luminaire is advantageous in that a relatively large number of LEDs may be arranged in the light guiding layer without causing excessive concentration of heat dissipating from the LEDs, since heat is efficiently distributed from the LEDs arranged in holes. Preferably, the LEDs are placed in an upper or lower surface of the layer, as opposed to being placed at an edge of the layer, which provides a relatively large area is available for placing the LEDs. Moreover, the inventive luminaire offers increased freedom in respect of where the LEDs shall be placed in the layer.

A first out-coupling structure may be arranged at an outer edge of the light guiding layer, for obtaining a favorable distribution of light.

The light guiding layer may comprise an inner edge that forms a through hole at the centre of the light guiding layer, and a second out-coupling structure may be arranged at the inner edge that forms said hole at the centre of the light guiding layer. This results in a lighter structure and in a more versatile distribution of light that provides for implementation of different angular distributions of light.

The luminaire may further comprise a heat-sink, for dissipating heat from the LEDs, and the heat-sink may be arranged at a distance from any inner and outer edge of the light guiding layer. This further improves the heat dissipation as well as improves the freedom of design of the luminaire.

The LEDs may be accommodated in plurality of holes arranged in the light guiding layer, and each of the holes accommodating a respective LED may comprise at least two side-facets and at least one corner, the two side-facets converging to form the corner. This is advantageous in that the direction of light may be efficiently controlled.

A corner of a hole accommodating a LED may point towards an adjacent LED-accommodating hole, and the lateral cross section shape of each of the LED-accommodating holes in the light guiding layer may be square, for reducing the risk that light emitting from one LED is incident on another LED.

The LEDs may be side emitting LEDs, which results in a compact design as well results in efficient in-coupling of light in the layer.

The plurality of LEDs may be arranged in a circular LED array, and the light guiding layer may be substantially circular, which provides a structure that has an improved optical performance.

The plurality of LEDs may be arranged in a linear LED array, the light guiding layer may be rectangular-shaped and the linear LED array may be arranged oblique with respect to the rectangular-shaped light guiding layer.

The light guiding layer may have the shape of a right triangle, the two cathetuses of the triangular light guiding layer each having a reflective edge, respectively, and the hypotenuse of the triangular light guiding layer comprising an out-coupling structure for coupling light out of the light guiding layer.

The luminaire may further comprise a second light guiding layer, and a second plurality of LEDs which are accommodated in at least one hole arranged in the second light guiding layer for emitting light into the second light guiding layer. The second light guiding layer comprises at least one out-coupling structure for coupling the light out of the second light guiding layer, and the second light guiding layer is arranged parallel with the first light guiding layer. Two layers are highly advantageous in that the light properties and distribution of the light from the luminaire may directed in a more versatile manner.

The at least one out-coupling structure of the first light guiding layer may be configured to couple out light in a first direction, the at least one out-coupling structure of the second light guiding layer being configured to couple out light in a second direction that may be opposite the first direction, for providing both task light and surrounding light.

The LEDs in the first light guiding layer may be configured to emit light having a first color spectrum, the LEDs in the second light guiding layer being configured to emit light having a second color spectrum that is different from the first color spectrum, which improves the versatility of the luminaire.

The first light guiding layer may comprise a first heat-sink, for dissipating heat from the LEDs of the first light guiding layer, the second light guiding layer comprising a second heat-sink, for dissipating heat from the LEDs of the second light guiding layer, the second heat sink being arranged opposite the first heat sink in a vertical direction. This makes it easier to handle the heat dissipation of the luminaire.

It should be noted that the term “luminaire” means a device that is used for providing light for purpose of illuminating objects e.g. in a room. A room is in this context typically an apartment room or an office room, a gym hall, a room in a public place or a part of an outdoor environment, such as a part of a street. Accordingly, an luminaire is not, for example, a video projector or a backlight for a TV or mobile phone.

### BRIEF DESCRIPTION OF THE DRAWINGS

Embodiments of the present invention will now be described, by way of example, with reference to the accompanying schematic drawings, in which

FIG. 1 is a perspective view of a circular luminaire according to the invention,

FIG. 2 is a top view of the luminaire in FIG. 1,

FIG. 3 is cross-sectional view taken along the line A-A in FIG. 2,

FIG. 4 is a partial top view of the luminaire in FIG. 1, illustrating a set of LEDs,

FIG. 5 is a cross-sectional view corresponding to FIG. 3, but of a luminaire according to a further embodiment,

FIG. 6 is a top view of a triangular luminaire according to the invention,

FIG. 7 is a top view of a rectangular luminaire according to the invention,

FIG. 8-11 are top views of various luminaire that has LEDs arranged in straight arrays, and

FIG. 12 is a cross-sectional view corresponding to FIG. 3, but of a luminaire incorporating multiple out-coupling structures.

### DETAILED DESCRIPTION

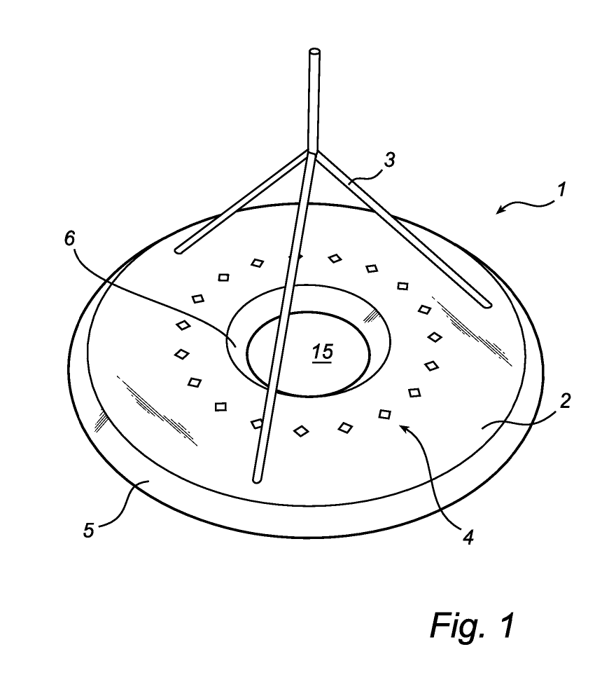

FIG. 1 illustrates a lamp 1, or luminaire, for lighting up a room, for example in an office, apartment, shop or other public area. The luminaire 1 has a hang-up device 3 that hangs a light guiding layer 2 to a ceiling (not shown). The light guiding layer 2 is, for example, transparent and can be made of glass or plastics, but can be made of any other suitable material. A set of LEDs 4 are arranged in the layer 2, and the set of LEDs are connected to and powered by a conventional power source (not shown).

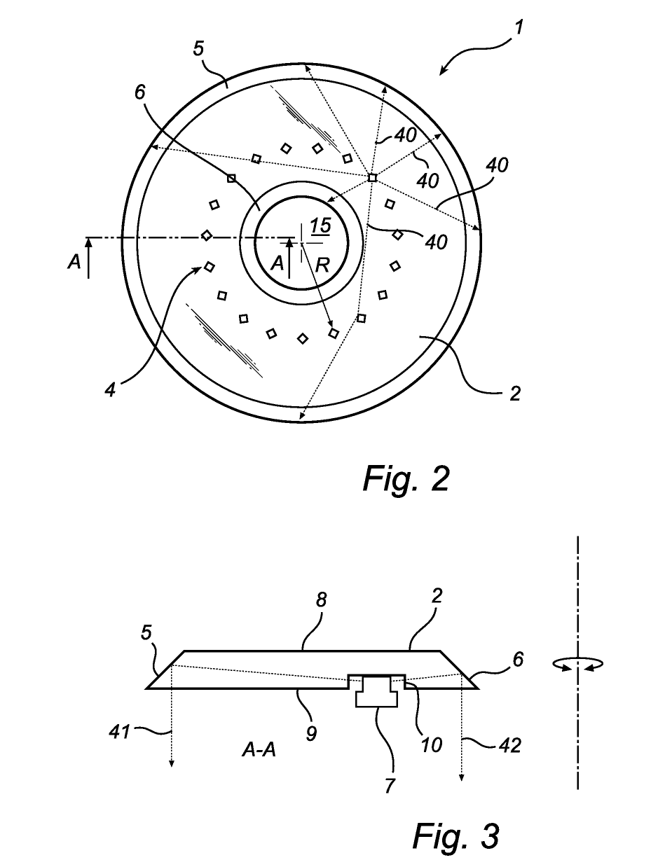

With further reference to FIGS. 2 and 3, the illustrated light guiding layer 2 has a circular shape, and a circular hole 15 is arranged in the centre of the layer 2. The set of LEDs 4 has a plurality of individual LEDs, generally designated 7, that are arranged in a circular array, a radial distance R from the centre of the light guiding layer 2. The perimeter, or outer edge of the light guiding layer 2, forms an outer out-coupling structure 5 that has a slanted surface in relation to a top surface 8 and a bottom surface 9 of the layer 2.

An inner edge of the light guiding layer 2 defines the previously described hole 15, and forms an inner out-coupling structure 6 that also has a slanted surface in relation to a top surface 8 and a bottom surface 9 of the layer 2.

Each LED 7 is arranged in a respective hole, generally designated 10, and is configured to emit light sideways, into the light guiding layer 2. Preferably the LEDs are side emitting LEDs. The light emitting part of the LED is arranged between the top 8 and bottom surface of the layer 2 and emits light, which is illustrated by exemplary ray traces 41 and 42, by total internal reflection (TIR) within the layer, towards both the outer out-coupling structure 5 and the inner out-coupling structure 6. The slanted surfaces of the out-coupling structures 5, 6 are each configured, in a conventional manner, to couple out the light 41, 42 in a downward direction.

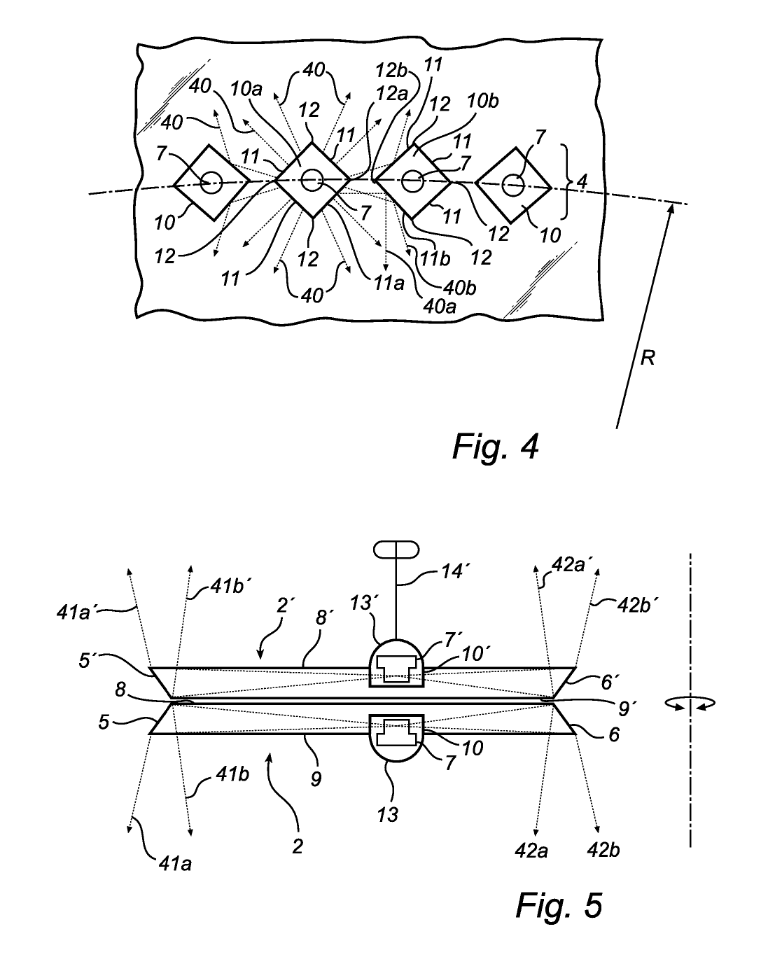

With further reference to FIG. 4 and as mentioned, the plurality of LEDs 7 are accommodated in the holes 10 which are arranged in the light guiding layer 2. The holes 10 could be through holes or holes having an opening towards one side of the light guiding layer 2 only. The LEDs 7 are preferably side-emitting omnidirectional LEDs. Alternatively, unidirectional LEDs or clusters of unidirectional LEDs that are aimed in opposite directions can be used.

Preferably each hole 10 in is square-shaped with four in-coupling side facets generally designated 11. Between each two adjoining in-coupling side facets 11, a corner generally designated 12 is formed. The corners of the square holes are 90°. When the LED 7 is in operation, light is coupled into the light guiding layer 2 through the side facets 11 and forms four beams of light rays essentially orthogonal to the respective side facets 11 of the hole 10.

The holes 10 are further oriented and placed such that at least one corner 12a of a hole 10a is pointing towards an adjacent hole 10b, as seen in the plane of the light guiding layer 2. More precisely, in the embodiment illustrated in FIGS. 1-4, the LEDs 7 (and consequently the holes 10) are arranged in a circular array 4 such that the corner 12a of the hole 10a is pointing substantially towards a corner 12b of the adjacent hole 10b, and the corner 12b of the adjacent hole 10b is pointing substantially towards the corner 12a of the holes 10a. In other words, the holes are rotated just above 45° from a position side along side.

Upon operation of the luminaire 17, light 40b in-coupled from hole 10a through side facet 11a into the light guiding layer 2 that hits the side facets 11b of the adjacent hole 10b does so at larger angles of incidence compared to, for example, holes that have a circular shape and the angle of incidence may be very small. The probability of TIR at the side facets 11b of the adjacent hole 10b is thereby significantly increased. Consequently, a smaller amount of light or no light at all from the hole 10a enters the adjacent hole 10b so that little or no scattering and/or absorption occurs at the LED 7 in that hole 10b. Overall, this increases the luminous efficiency of the luminaire 17.

The light guiding layer 2 may further comprise additional means (not shown), such as tilted reflective elements or diffusive particles, arranged between the outer 5 and inner 6 out-coupling structure, for diffusing and thereby coupling out light from the upper 8 or lower 9 surface at a location between the out-coupling structures 5 and 6.

TIR in the above context presumes the that light from a hole 10a strikes a side facet 11b of an adjacent hole 10b at a sufficiently large angle of incidence given the light guiding layer 2 and hole 10 materials. The angle of incidence is measured with respect to the normal at the refractive boundary. For a light guiding layer 2 made of glass (refractive index n of about 1.5) and holes 10 filled with air, such an angle of incidence is in the order of arcsin 1/n=42°. To this end, in the above embodiment, any light 40a exiting the hole 10a at 42° or less with respect to the side facet normal towards the nearest side facet 11b of hole 10b will hit that side facet at 48° or more (>42°, safety margin of 6°) (or not hit the side facet 11b at all), and will consequently be reflected without entering the hole 10b. In contrast, any light exiting the hole 10a at say 50° or more towards the side facet 11b of hole 10b would hit that side facet at 40° or less (<42°), and would thus enter the hole 10b. However, when using an omnidirectional side-emitter in a square-shaped hole as above, the angle of departure cannot exceed 42°, as will be appreciated by a person skilled in the art.

Also, the angles of departure and incidence and thus the occurrence of TIR depend on the shape of the holes. Namely, the probability of TIR at an adjacent hole is generally larger for opposing acute angle corners than for opposing obtuse angle corners. To this end, the relative angle between the exit side facet 11a and the receiving side facet 11b of adjacent holes, which angle depends on the corner radius the alignment of the adjacent holes and the radius R, should be sufficiently large to allow TIR.

Instead of a plurality of holes, the layer may have one hole in the form of, for example, a circular recess in the layer. Preferably such a circular hole, or recess, has its center aligned with the centre of the layer. This is advantageous from a manufacturing point of view, in particular if the layer is made of glass.

With reference to FIG. 5, a further embodiment of the luminaire has a lower light guiding layer 2 that that has same components as the light guiding layer described above in association with FIGS. 1-4. An upper light guiding layer 2′ corresponds to the lower light guiding layer 2, has same components, and same reference numerals but with a prim sign. The upper layer 2′ is, in relation to the lower layer 2, rotated about a horizontal axis and is placed on top of the lower layer 2. Accordingly, the layers 2 and 2′ are parallel, but separated by a suitable medium so that light from a LED is allowed to travel via TIR to the respective out-coupling structures. Accordingly, rays of light 41a, 41b, 42a, 42b from LEDs 7 in the lower light guiding layer 2 are directed downwards, while rays of light 41a′, 41b′, 42a′, 42b′ from LEDs 7′ in the upper light guiding layer 2′ are directed upwards.

Moreover, a lower heat sink 13 is arranged at the lower layer 2 and is configured to dissipate heat generated by the lower LEDs 7, and an upper heat sink 13′ is arranged at the upper layer 2′ is and configured to dissipate heat generated by the upper LEDs 7′. Preferably the sinks 13, 13′ are arranged opposite each other in a vertical direction. To improve heat dissipation a heat pipe 14′ is thermally connected to the sink 13′. The heat sinks 13 and 13′ may be thermally connected to each other. It is also possible to thermally connect the lower LEDs 7 and the upper LEDs 7′ to only one, common heat sink.

One or more through holes for a heat sink (not shown) may be arranged in the light guiding layer for thermally connecting the LEDs to a common heat sink. In this case, the hole(s) for the heat sink is preferably configured to reflect light that is emitted from the LEDs, for preventing that light enters the hole(s) for the heat sink.

To obtain different light properties, in the described embodiment, the LEDs 7 of the first light guiding layer 2 are white and the LEDs 7′ of the second light guiding layer 2′ are red, green and blue.

Optionally, the two layers may be arranged to both couple out light in a downwards direction. In this case the layers preferably couple out light at different angular distributions, and it is preferred that the two layers have different sizes. Of course, the luminaire may comprise more than two layer with respective holes and LEDs.

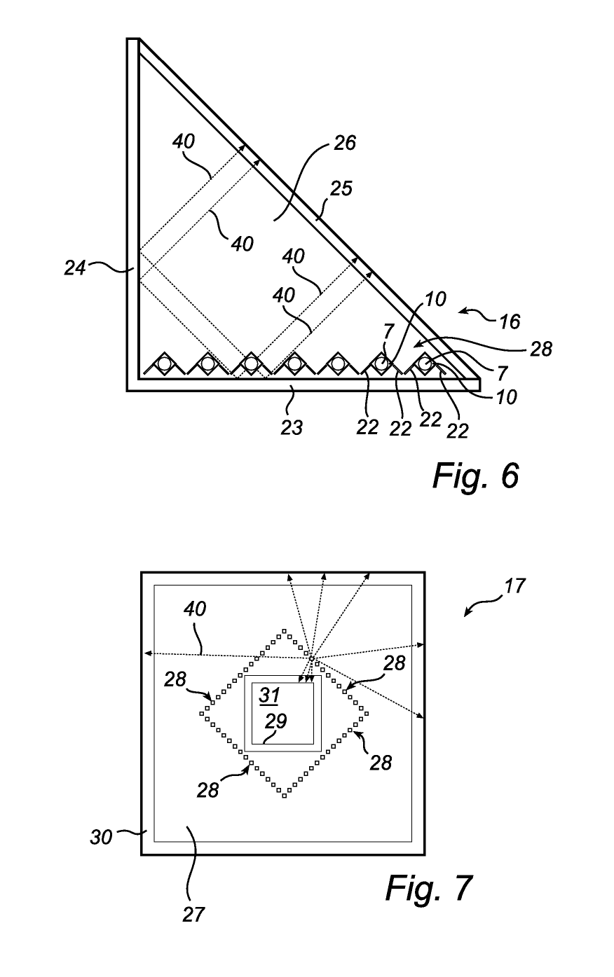

FIG. 6 schematically illustrates a triangular luminaire 16. Here, the light guide plate 28 has the shape of a right triangle. The reflective edge 23, along which the LEDs 7 are placed, constitutes one cathetus or leg side of the right triangle. The other cathetus is also a reflective edge 24 and the hypotenuse comprises an out-coupling structure 25 in the form of a tilted reflective edge. The reflective edge can for example be a TIR mirror, a diffuse mirror or a regular mirror.

Upon operation, light emitted from all four side facets of each hole 10 is directed towards the out-coupling structure 25, either directly or via at least one of the reflective cathetus edges 23 and 24, and hits the out-coupling structure 25 at an essentially right angle. This is illustrated by exemplary ray-traces 40 and it provides for a uniform and collimated light distribution.

However, in the triangular embodiment, even though square holes 10 arranged corner to corner are used, light from one can be reflected by towards another nearby hole with such an angle of incidence that TIR does not occur and the light enters the hole and is scattered and/or absorbed at the LED accommodated in the hole.

To prevent this, the light guide plate 28 is provided with a plurality of air slits 22 arranged such that light reflected by the edge is aimed towards the spaces between the holes 10. For square holes rotated about 45° with respect to the reflective edge 23 and placed close to the reflective edge 23, the air slits 22 extend between the hole 10 and the reflective edge 23 in the extension of the side facets facing away from the reflective edge 23.

The triangular luminaire 16 just described can advantageously be placed in a corner of a room. Except for illumination purposes, it can also serve as a shelf, for instance for a television set. It should be noted that the triangular luminaire 16 could be embodied without the slits 40, but such a triangular luminaire 16 would have a somewhat degraded performance. Also, the out-coupling structure 48 could instead of being straight be curved in the longitudinal direction.

FIG. 7 schematically illustrates a rectangular shaped, or more specifically, a square shaped luminaire 27. Here a hole 31 with square shape is provided in the centre of the light guide plate 27, and the resulting inner edges 29 are adapted to couple light out of the light guide plate 27. Four linear arrays 28 of the type discussed in relation to FIG. 4 (except for the radius R) above are further provided in the light guide plate 27. Namely, the four arrays 28 with holes and LEDs form a square rotated about 45° in relation to the light guide plate 27, which square is placed around the center hole 31. That is, the arrays 28 are aligned with the diagonal direction of the light guide plate 27 so that the side facets of the holes are parallel to the out-coupling edges 29 and 31 of the light guide plate 27. In this way, during operation, most light beams emanating from the holes hits the edges 29 and 30 from an essentially perpendicular direction, which results in uniform and collimated light coupled out from the light guide plate 27.

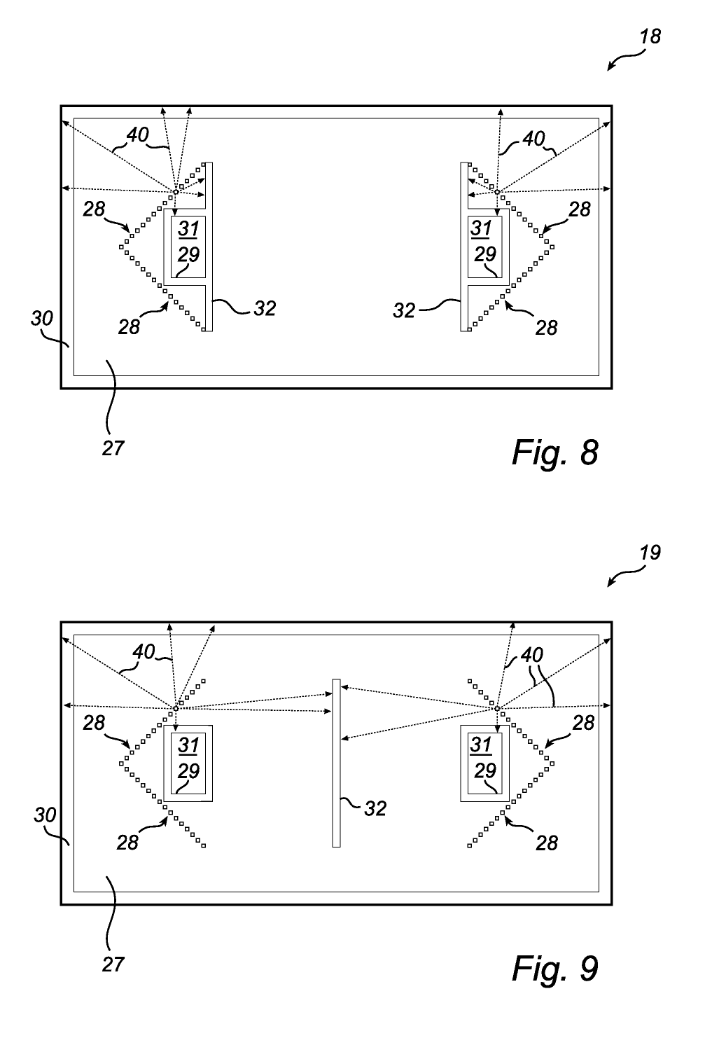

FIGS. 8 and 9 illustrate other rectangular luminaries 18 and 19 wherein basically the square centre hole and rotated square of four arrays from FIG. 7 are split in two and distanced from each other, forming two sets each comprising two linear arrays 28 arranged in a right angle and a hole 31 with rectangular shape and out-coupling edges 29. Additional out-coupling structures 32 can be arranged at each set, or a single out-coupling structure 32 can be placed between the two sets. The out-coupling structure 32 can for example be a tilted mirror or the like.

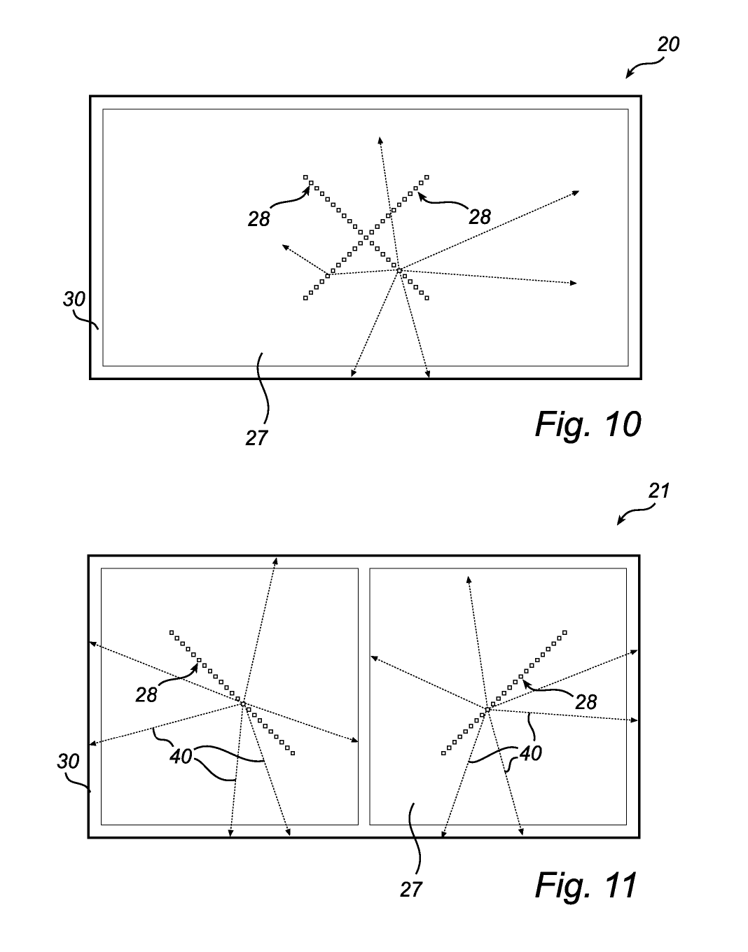

FIG. 10 illustrates another rectangular luminaire 20 wherein two linear arrays 28 form an “X” located in the middle of the light guide plate 27.

FIG. 11 illustrate yet another rectangular luminaire 21 having two arrays 28 of LEDs are arranged at an angle of 45° in relation an out-coupling structure 30 arranged at the edge of the layer 27 and separating the two arrays. In addition, the two arrays are mutually rotated 90°.

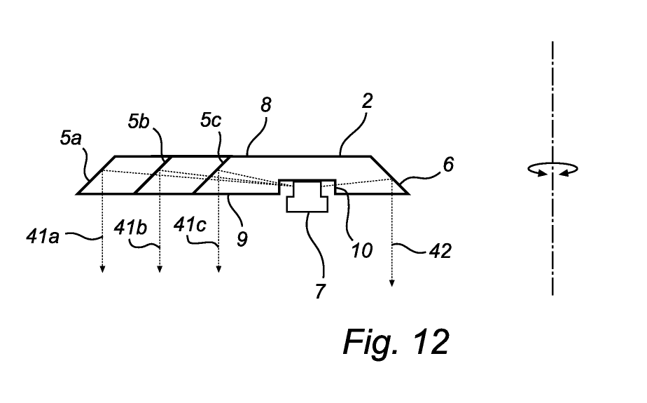

Finally, FIG. 12 illustrates a light guiding layer 2 that has three out-coupling structures 5a, 5b and 5c. Each of the out-coupling structures 5a, 5b, 5c directs light in a respective direction, which is illustrated by exemplary ray traces 41a, 41b and 41c. For example, one of the structures may couple out light in a direction that focuses light on a specific spot in the room, while the two other out-coupling structures couple out light in at least one different direction. The out-coupling structures 5b and 5c that are arranged between the hole 10 and the outermost out-coupling structure 5a do not couple out all light, but allow passage of some part of the light. Moreover, additional out-coupling structures may arranged between the hole 10 and the inner out-coupling structure 6.

The person skilled in the art realizes that the present invention by no means is limited to the preferred embodiments described above. On the contrary, many modifications and variations are possible within the scope of the appended claims.

It is possible to use light guiding layers of other shapes of than the ones described above, such as elliptical, octagonal, star shaped, moon shaped or any other shape. Moreover, for obtaining different lighting properties, the number of arrays of LEDs may varied, and the arrays may have any other form apart from straight and circular, such as zigzagged, wave shaped, or any combination thereof. The relative location of the LED-array(s) may be varied in respect of the out-coupling structure(s).

1. A luminaire comprising
a light guiding layer (2), and
a plurality of LEDs (7), which LEDs (7) are accommodated in at least one hole (10) arranged in the light guiding layer (2), for emitting light into the light guiding layer (2), wherein
the light guiding layer (2) comprises at least one out-coupling structure (5; 6), for coupling the light out of the light guiding layer (2).

2. A luminaire according to claim 1, wherein a first out-coupling structure (5) is arranged at an outer edge of the light guiding layer (2).

3. A luminaire according to claim 1, wherein the light guiding layer (2) comprises an inner edge that forms a through hole (15) at the centre of the light guiding layer (2).

4. A luminaire according to claim 3, wherein a second out-coupling structure (6) is arranged at the inner edge that forms said hole (15) at the centre of the light guiding layer (2).

5. A luminaire according to claim 1, further comprising a heat-sink (13), for dissipating heat from the LEDs (7).

6. A luminaire according to claim 5, wherein the heat-sink (13) is arranged at a distance from an inner and/or an outer edge of the light guiding layer (2).

7. A luminaire according to claim 1, wherein the LEDs (7) are accommodated in a plurality of holes (10) arranged in the light guiding layer (2).

8. A luminaire according to claim 7, wherein each of the LED accommodating holes (10) comprises at least two side-facets (11) and at least one corner (12), the two side-facets (11) converging to form the corner (12).

9. A luminaire according to claim 7, wherein a corner (12) of a hole (10) accommodating a LED points towards an adjacent LED-accommodating hole.

10. A luminaire according to claim 7, wherein the lateral cross section shape of each of the LED-accommodating holes in the light guiding layer is square.

11. A luminaire according to claim 1, wherein the LEDs are side emitting LEDs.

12. A luminaire according to claim 1, wherein the plurality of LEDs (7) are arranged in a circular LED array (4).

13. A luminaire according to claim 1, wherein the light guiding layer (2) is substantially circular.

14. A luminaire according to claim 1, wherein the plurality of LEDs are arranged in a linear LED array (28), the light guiding layer being rectangular-shaped and the linear LED array being arranged oblique with respect to the rectangular-shaped light guiding layer.

15. A luminaire according to claim 1, wherein the light guiding layer has the shape of a right triangle, the two cathetuses of the triangular light guiding layer each having a reflective edge, respectively, and the hypotenuse of the triangular light guiding layer comprising an out-coupling structure (48) for coupling light out of the light guiding layer.

16. A luminaire according to claim 1, further comprising
a second light guiding layer (2′), and
a second plurality of LEDs (7′) which are accommodated in at least one hole (10′) arranged in the second light guiding layer (2′), for emitting light into the second light guiding layer (2′),
the second light guiding layer (2′) comprising at least one out-coupling structure (5′; 6′), for coupling the light out of the second light guiding layer (2′), wherein the second light guiding layer (2′) is arranged parallel with the first light guiding layer (2).

17. A luminaire according to claim 16, wherein the at least one out-coupling structure (5; 6) of the first light guiding layer (2) is configured to couple out light in a first direction, the at least one out-coupling structure (5′; 6′) of the second light guiding layer (2′) being configured to couple out light in a second direction that is opposite the first direction.

18. A luminaire according to claim 16, wherein the LEDs (7) in the first light guiding layer (2) are configured to emit light having a first color spectrum, the LEDs (7′) in the second light guiding layer (2′) being configured to emit light having a second color spectrum that is different from the first color spectrum.

19. A luminaire according to claim 16, wherein the first light guiding layer (2) comprises a first heat-sink (13), for dissipating heat from the LEDs (7) of the first light guiding layer (2), the second light guiding layer (2′) comprising a second heat-sink (13′), for dissipating heat from the LEDs (7′) of the second light guiding layer (2′), the second heat sink (13′) being arranged opposite the first heat sink (13) in a vertical direction.
